(19) United States
(12) Patent Application Publication
(10) Pub. No.: US 2012/0140067 A1
(43) Pub. Date: Jun. 7, 2012

(54) High Definition Imaging Over Legacy Surveillance and Lower Bandwidth Systems

(76) Inventor: Scott Crossen, (US)

(21) Appl. No.: 12/961,594

(22) Filed: Dec. 7, 2010

(51) Int. Cl. H04N 7/18; G06K 9/34; H04N 7/01

(52) U.S. Cl. 348/143; 382/173; 348/443; 348/E07.085

(57) ABSTRACT

A video apparatus with high-resolution imaging device capable of producing standard or lower resolution images from a random or selected and variable region of viewing area.

### FIELD OF INVENTION

This invention relates to a video apparatus with high-resolution imaging devices capable of producing standard and/or lower resolution images from a selected and variable region of viewing area or automated zoom, pan and scroll.

### BACKGROUND OF THE INVENTION

NTSC (USA and others) and PAL (Europe/Japan) are the television and CCTV standards that are used around the world for video transmission and storage. Current security and other applications are limited by modest resolution capabilities. NTSC, for example, uses an image size of only 512 lines. Current digital imaging devices are capable of thousands of lines of resolution and that number is growing at a rapid rate. Because of the high cost of purchase and deployment of an ever changing technology, all but the most specialized tasks have settled on using the standards mentioned above. This invention allows the use of a high resolution camera while using lower resolution infrastructures.

### SUMMARY OF INVENTION

The present invention includes the steps of capturing a series of video frames, establishing a set of Cartesian coordinates representing a region or interest or a region in which motion is present in the video frames, normalizing the coordinates to a different video size or one of the common video transmission standards like the group consisting of National Television System Committee (NTSC), Phase Alternating Line (PAL) and Sequential Couleur Avec Memoire or Sequential Colour with Memory (SECAM) and transmitting the video frame cropped to the normalized coordinates over the selected video transmission standard.

An alternative embodiment of the invention includes the steps of capturing an image and detecting a plurality of regions of interest in the image. These regions of interest are typically based on the detection of movement. Each image region of interest is cropped into sub-images to accommodate a lower-resolution transmission standard. The cropped images are then transmitted to a destination in a repeating sequence. The image sequences associated with each region of interest are grouped for viewing at the destination. Thus, if the frame rate of the lower-resolution transmission standard is 30 frames per second, and there are three (3) regions of interest, then the resultant frame rate at the destination for each region will be 10 frames per second. However, the resolution for each region of interest will be greatly improved by the present invention since only the area of interest is transmitted and presented. Alternatively, multiple viewpoints or regions of interest can be multiplexed and transmitted as alternating frames within the video stream. Specialized software could then separate out the individual frames to create separate, lower frame rate video clips.

### BRIEF DESCRIPTION OF THE DRAWINGS

For a fuller understanding of the invention, reference should be made to the following detailed description, taken in connection with the accompanying drawings, in which:

FIGS. 1-4 are scene images of a vehicle at various resolutions and frame croppings.

FIGS. 5-6 are diagrammatic matrixes representing the detection of motion within sub-regions of an image.

FIG. 7 is a diagrammatic view of an embodiment of the invention that captures an image at high resolution, detects a region of motion within the image and transmits the region via lower-resolution legacy equipment.

FIG. 8 is an exemplary full-frame image of a hallway showing a person at a door.

FIG. 9 is a cropped image of FIG. 8, showing the person at the door.

FIG. 10 is an enlarged and enhanced image of FIG. 9.

FIG. 11 is the same image region as shown in FIG. 9 but capture at high resolution.

FIG. 12 is an enlarged and enhanced image of FIG. 11.

FIG. 13 is a side-by-side comparison of FIG. 10 (low resolution) and FIG. 12 (high resolution).

### DETAILED DESCRIPTION OF THE PREFERRED EMBODIMENT

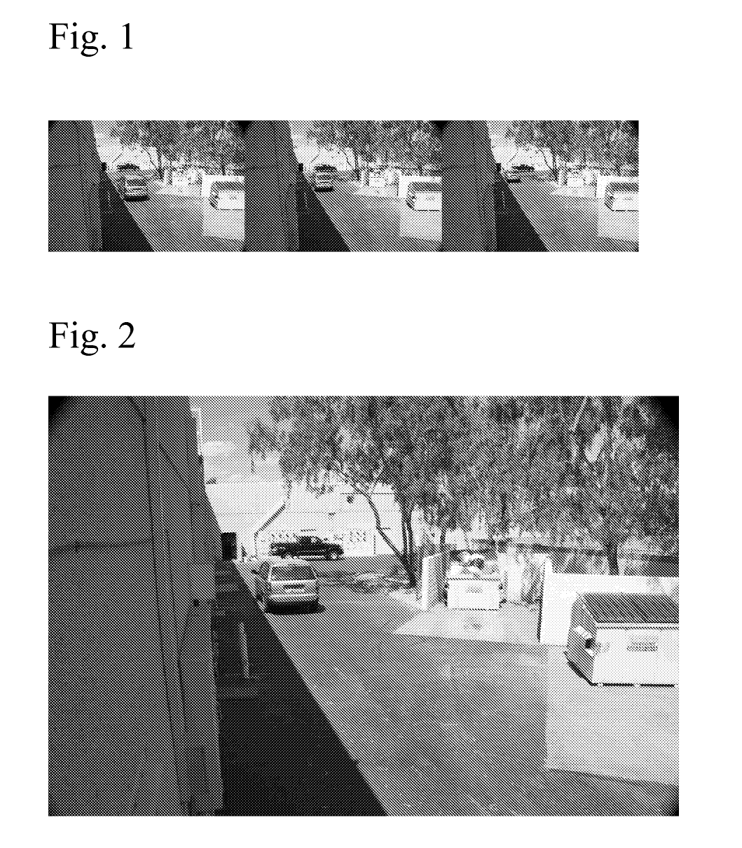

FIG. 1 shows a series of frames showing motion. These images were captured with an 8 Mega Pixel camera. Most security applications produce an image of ⅓ of a Mega Pixel. Notice how the automobile moves across the scene. Each frame will differ from the previous in the pixels where motion occurs making it easy to identify the moving object and then selecting a surrounding area.

FIG. 2 is one of the images from above but shown with 512 lines of resolution or ⅓ of a Mega Pixel as would be represented by standard NTSC video.

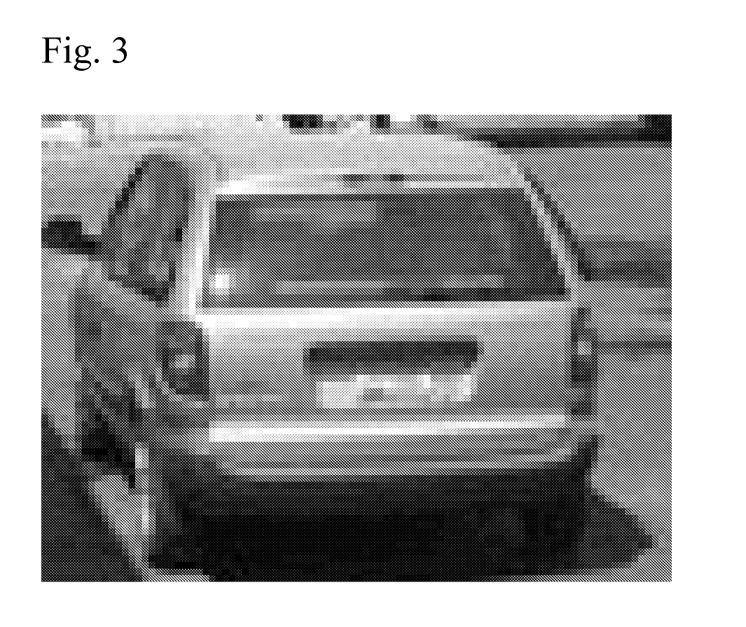

FIG. 3 is zoomed in from FIG. 2's 512 line image to look at license plate details. There is not enough information present to extract a plate number. Even sophisticated software could not extract a plate number from this photo. This is the kind of information or lack of information that law enforcement and security officials receive everyday.

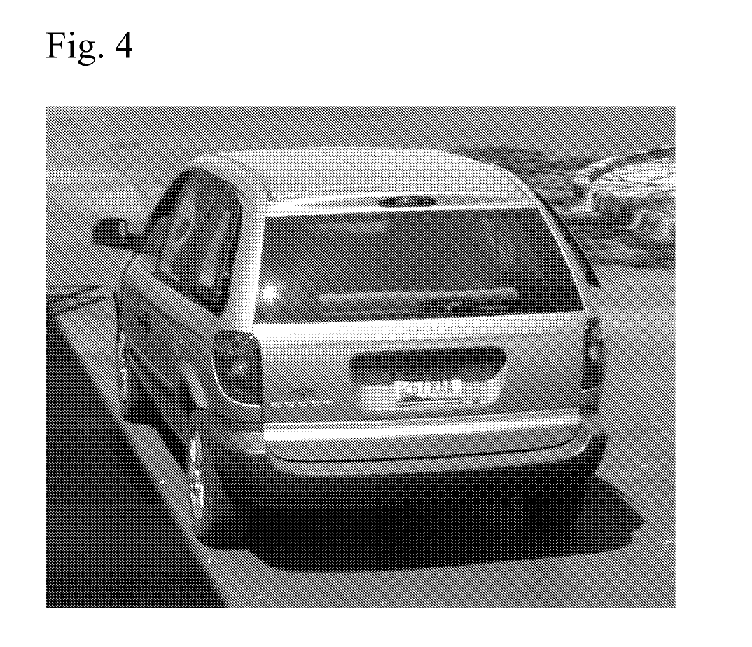

FIG. 4 is zoomed in from the 8 Mega Pixel image to just the area surrounding the region of motion then presented as 512 lines. Since it is not necessary to send the part of the image that hasn't been changing, we can dedicate all of our ⅓ Mega Pixels of NTSC video to just the area around the motion, or van, in this case. This is the image that the camera would send to be recorded or viewed. The plate is clearly visible as are the make and model of the van.

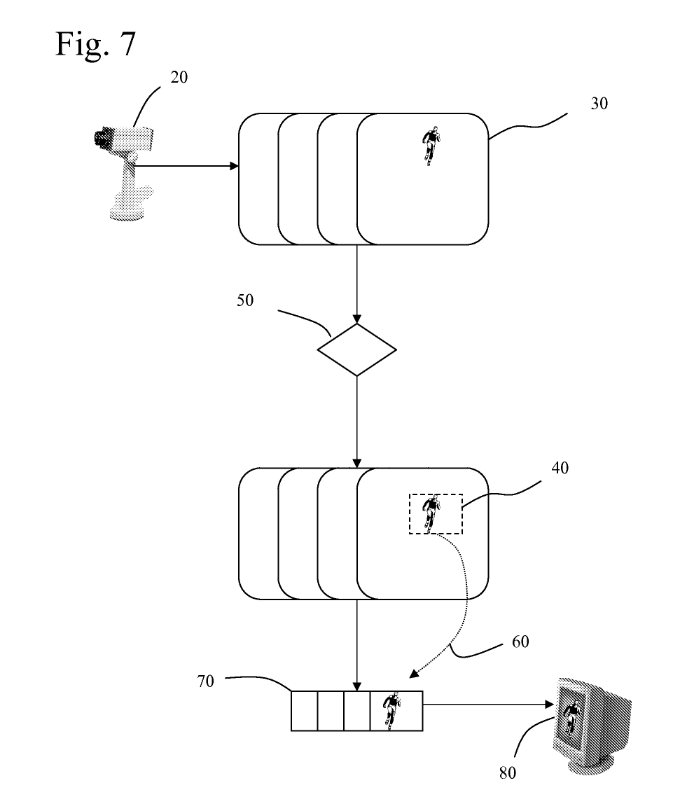

An embodiment of the general inventive concept is illustrated in FIG. 7 wherein high-resolution digital camera 20 records an array of high-resolution frames 30. The region of motion 40 is detected 50 and cropped 60 to a lower resolution standard 70 which can be transmitted over limited infrastructure to its destination 80.

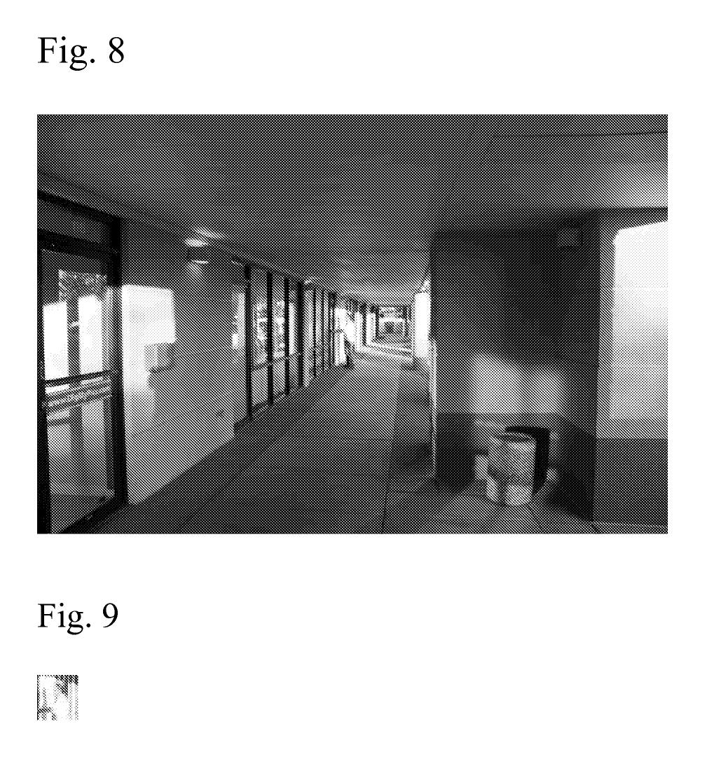

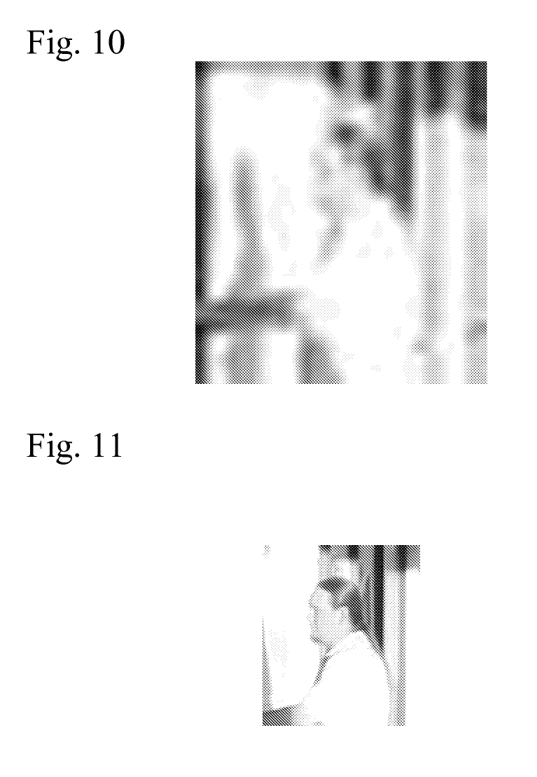

For the purposes of this specification, the image presented in FIG. 8 is assumed to be of a lower-resolution standard such as NTSC. The precise resolution is not critical, only that the resolution of the capture device is substantially greater than the resolution of the infrastructure that must ultimately transmit the image to its destination. Suppose the region is interest relates to the person at the door in FIG. 8. If zoom in with this image, the image in FIG. 9 in returned. Even if digitally enhanced and extrapolated the image of FIG. 10 is still difficult to discern.

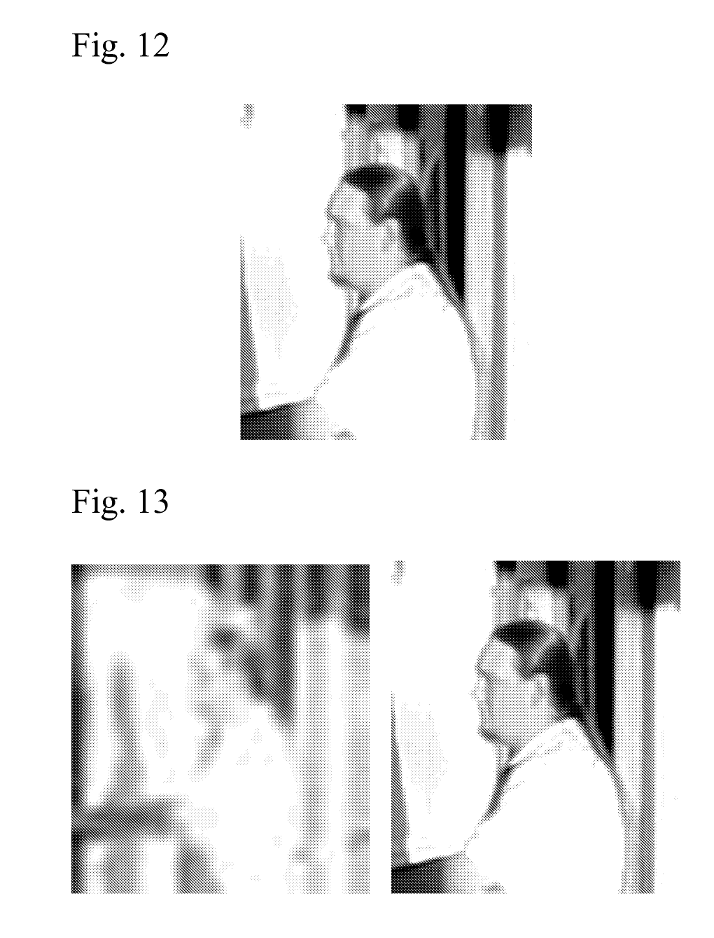

Not enough information exists in FIG. 10 to make identification. Initial image capture by a high resolution device provides the version of FIG. 11 which is digitally enhanced in FIG. 12. A side-by-side comparison of the two images is provided in FIG. 13. The second image (to the right in FIG. 13) provides a much more detailed reproduction.

This apparatus works by using a hi-resolution imaging device but only transmits standard resolution images and optionally transmits standard resolution images of a region of interest triggered by motion or movement or other types of triggers of interest in that area. The apparatus is smart enough to detect the trigger then find a surrounding area and convert that area to standard resolution for transmission.

The apparatus can also transmit data relating to information about the region inside the video image pixels it sends and/or within the various sync and timing signals inside standard video signals much like closed captioning sends text.

Another option to this apparatus is for dealing with multiple regions of interest. Standard resolution sends frames at 30 frames per second (fps) for NTSC and 25 fps for PAL. This apparatus can use those frames to send snapshots of various activities within the larger frame. Software is used to separate out the frames giving clear snapshots of a variety of action points.

This apparatus could also be programmed to round robin between various regions, regardless of motion.

This apparatus could be used in applications other than security such as a sporting event which is being monitored by a camera of extreme resolution. The camera, using these techniques, could follow the action, gracefully panning, scrolling and zooming in and out of various regions within its view.

### Technical Details

### Motion Based Cropping of High-Resolution Image to Standard Resolution for Transmission

Images stream in at a constant rate, generally 30 frames per second. To detect motion, or changes, a simple comparator is used to subtract one from the next. Two identical images subtracted from one another will equal 0 but if there is a change the resulting subtraction will be non-zero.

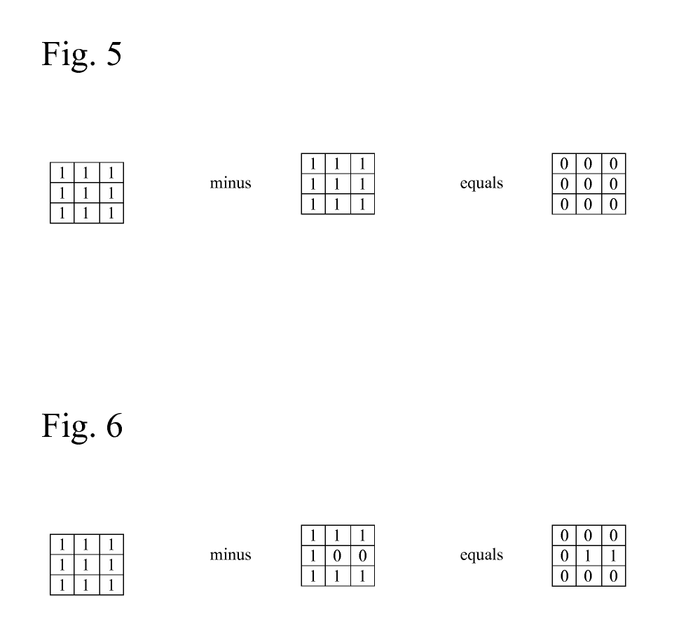

To simply things, imagine a simple image in the matrix of FIG. 5. Note: this is a simple 3×3 matrix. A hi res image can have a matrix of 3000×3000 or more and each value will range from 0 to 255 or more per color.

The matrix of FIG. 6 shows motion. Motion is detected in the non-zero region or the resulting frame. Now make that region the center of the image and expand in the all direction until the desired frame size is achieved. Transmit that region of the live image.

What if the region of motion is larger than 640×480? We can sub-sample the region by skipping every other pixel in each direction or every 3^{rd} pixel or every n^{th} pixel until we can fit the region of interest into our frame size.

The logic to achieve this is quite simple and can easily be done with inexpensive, off-the-shelf microprocessors.

### Multi-Frame Transmission of High Definition Image over Lower Definition Infrastructure and Decoding Thereof

Video is transmitted as individual frames, snapshots in time, but when combined in rapid succession, the eye perceives fluid motion. Modern video equipment is designed to capture and store individual frames of video.

Current American standards send frames at 30 frames per second (fps). Not all circumstances require 30 fps to understand what's happening in the field of view.

Using current NTSC video standards, a frame is 480 lines or 480 pixels in the vertical direction and each line is an analog signal that is usually divided into 640 pixels. Given that, we can capture a snapshot from a video camera that is 640×480 pixels and we can capture 30 of those frames in each second.

Using a sensor that has a frame size of 6400×4800, 100 times current video standards but available today, we could to get 10 frames from the x axis and 10 frames down the y axis. Conceivable 100 frames of standard video from each 640×480 region of the large sensor.

We can use the logic above to find a 640×480 region of interest based on motion and then just transmit that region. What if we have multiple area of interest or motion we wish to transmit? Using the fact that video is a succession of individual photos or frames, we can alternate between individual areas of interest sending one region, then the next then the next etc, then back to the first. Since Digital Video Recorders (DVR) capture every frame, we can digitally review each frame one at a time and see each region of interest.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. Capturing an image, detecting a region of interest in the image, cropping the image around the region to accommodate a lower-resolution transmission standard, and transmitting the cropped image to a destination.

2. Capturing a series of surveillance video frames, establishing a set of Cartesian coordinates representing a region in which motion is present in the video frames, normalizing the coordinates to a video transmission standard such as that of National Television System Committee (NTSC), Phase Alternating Line (PAL) and Sequential Couleur Avec Memoire or Sequential Colour with Memory (SECAM) and transmitting the surveillance video framed cropped to the normalized coordinates over the selected video transmission standard.

3. Capturing an image, detecting a plurality of regions of interest in the image, cropping the image around each region to accommodate a lower-resolution transmission standard, transmitting the cropped images to a destination sequentially, and grouping image sequences associated with each region of interest for viewing.

4. Transmitting various programmable or random regions from a high resolution imaging device in a sequence at lower resolution.

5. Automated zooming, panning and scrolling by use of a large sensor for transmission as lower resolution images.
